(19) United States
(12) Patent Application Publication
(10) Pub. No.: US 2002/0077112 A1
(43) Pub. Date: Jun. 20, 2002

(54) Distributed cellular network communication system

(76) Inventors: Chris P. McIntosh, San Francisco, CA (US); Priscilla Marilyn Lu, San Carlos, CA (US)

Correspondence Address: FLEHR HOHBACH TEST ALBRITTON & HERBERT LLP, Suite 3400, Four Embarcadero Center, San Francisco, CA, 94111-4187, US

(21) Appl. No.: 09/938,098

(22) Filed: Aug. 23, 2001

Related U.S. Application Data
(63) Continuation-in-part of application No. 09/295,058, filed on Apr. 20, 1999.
(60) Provisional application No. 60/227,392, filed on Aug. 23, 2000.
(60) Provisional application No. 60/099,051, filed on Sep. 3, 1998.

(51) Int. Cl. H04Q 7/20

(52) U.S. Cl. 455/453; 455/450

(57) ABSTRACT

A distributed cellular network (100) provides wireless communication with a plurality of mobile stations (102). A plurality of base transceiver station network elements (104) are configured to communicate with the plurality of mobile stations (102) over a wireless medium, wherein each base transceiver station includes a network interface adapted to couple to a network (110). A plurality of base station controller network elements (106) each include a network interface adapted to couple to the network (110). At least one mobile station controller network element (108) includes a network interface adapted to couple to the network (110). The system (100) is configured such that communication traffic among the base transceiver stations (104), the base station controllers (106) and the mobile switching center (108) is load-balanced for efficiency. Advantages of the invention include a combination of low-cost transceiver (104) and flexible deployment to gain communication coverage over a large area at a low cost.

### REFERENCE TO RELATED APPLICATIONS

This application claims priority to Prov. No. 60/227,392 filed Aug. 23 2000 and is a continuation-in-part of U.S. Ser. No. 09/295,058 filed Apr. 20, 1999 claiming priority to Prov. No. 60/099,051 filed Sep. 3, 1998. This application is also related to U.S. Pat. Nos. 6,173,177, 6,101,400, 5,842,138 and 5,734,979, all of which are incorporated herein by reference.

### FIELD

The present invention relates to a distributed cellular network communication system. In particular, the invention provides a distributed cellular network communication system that balances the processing and signaling load by directing communication traffic to network elements that can efficiently perform the required functions. This approach promotes flexible deployment and scaling of the network capacity based on user and system demand.

### BACKGROUND

Cellular communication systems are well known in the art. In a typical cellular system, a plurality of base transceiver stations (BTS) are deployed at a plurality of remote locations to provide wireless telephone coverage. Each BTS serves a corresponding cell and when a mobile station (MS) enters the cell, the BTS communicates with the MS. Coverage over a large area is achieved by placing a plurality of BTSs on the area. A conventional cellular network of this type is described in D. M. Balston & R. C. V. Macario Cellular Radio Systems, (Artech House 1993).

One drawback to the conventional cellular network is that each BTS represents a significant amount of hardware. For example, each conventional BTS includes a plurality of antennas, a plurality of transceivers, a plurality of signal processors, a central processor and an interface processor. With all this hardware, each BTS also represents a significant cost. Moreover, since the antennas are often placed outside such as on top of buildings or in other locations experiencing weather elements, the BTS electronics are subject to large temperature fluctuations and weather conditions that can reduce the longevity of the electronics.

Additionally, network and switching subsytem (NSS) architecture supports the main switching functions of the cellular network as well as the databases needed for subscriber data and mobility management. The main role of the NSS is to manage the communications between the mobile users and other telecommunication network users. The NSS handles most of the signaling, number and location of transit exchanges and signaling transfer points. In conventional cellular architectures and techniques, the NSS is not capable of handling the switching and call routing that will enable a more flexible cellular deployment.

What is needed is a cellular network that combines a low-cost transceivers with a flexible deployment technique to gain communication coverage over a large area at a low cost. What is also needed is a radio management system to manage such a cellular network.

### SUMMARY

The invention overcomes the identified problems and provides a distributed cellular network that combines highly functional network elements over a network to efficiently distribute and balance the communication processing load. The invention also provides a flexible deployment technique to gain communication coverage over a large area at a relatively low cost.

An exemplary embodiment of a distributed cellular network provides wireless communication with a plurality of mobile stations. A plurality of base transceiver station network elements are configured to communicate with the plurality of mobile stations over a wireless medium, wherein each base transceiver station includes a network interface adapted to couple to a network. A plurality of base station controller network elements each include a network interface adapted to couple to the network. At least one mobile station controller network element includes a network interface adapted to couple to the network. The system is configured such that communication traffic among the base transceiver stations, the base station controllers and the mobile switching center is load-balanced for efficiency.

Advantages of the invention include a combination of low-cost transceiver and flexible deployment to gain communication coverage over a large area at a low cost.

### BRIEF DESCRIPTION OF THE FIGURES

Additional advantages of the invention will become apparent upon reading the following detailed description and upon reference to the drawings, in which:

FIG. 1 depicts a cellular network communication system according to the prior art;

FIG. 2 depicts the association of GSM protocols with GSM interfaces according to the prior art;

FIG. 3 depicts the general protocol architecture of a GSM system according to the prior art;

FIG. 4A depicts a cellular network according to an embodiment of the invention;

FIGS. 4B through 4E depict exemplary logical communications connections of the cellular network of FIG. 4A according to embodiments of the invention;

FIGS. 5A through C depict exemplary logical communications connections of the cellular network of FIG. 4A based on mobile station loads according to embodiments of the invention;

FIG. 6 depicts a concentrated base transceiver station (CBTS) and remote transceivers (RTRXs) according to an embodiment of the invention;

FIG. 7 depicts a concentrated base transceiver station (CBTS) and remote transceivers (RTRXs) according to another embodiment of the invention;

FIG. 8 is a block diagram of an embodiment of the invention for use in a configurable chassis;

FIG. 9 depicts a configured chassis according to an embodiment of the invention;

FIG. 10 depicts a configured chassis according to another embodiment of the invention;

FIG. 11 is a table depicting various embodiments of the invention;

FIG. 12 is an alternate architecture according to an embodiment of the invention;

FIG. 13 is another alternate architecture according to an embodiment of the invention;

FIG. 14 is yet another alternate architecture according to an embodiment of the invention;

FIG. 15 is still another alternate architecture according to an embodiment of the invention; and

FIG. 16 is a simplified block diagram of a communications system implemented using software functional blocks coupled via a network according to an embodiment of the invention.

### DETAILED DESCRIPTION

Exemplary embodiments are described with reference to specific configurations. Those skilled in the art will appreciate that various changes and modifications can be made while remaining within the scope of the claims. For example, the exemplary embodiments employ a GSM standard, but any TDMA, FDMA, CDMA, 3G (third generation) or other type standard can also be employed.

For purposes of this description, the term base station (BS) includes the structure and features present in any of the BTS, BSC, or MSC. Likewise, the term network element includes the structure and features present in any of the BTS, BSC, or MSC depending on the structures and features described with respect to the specific network element. The exemplary embodiments are capable of performing any of these functions depending on their individual configuration, as explained below.

A. Network Architecture

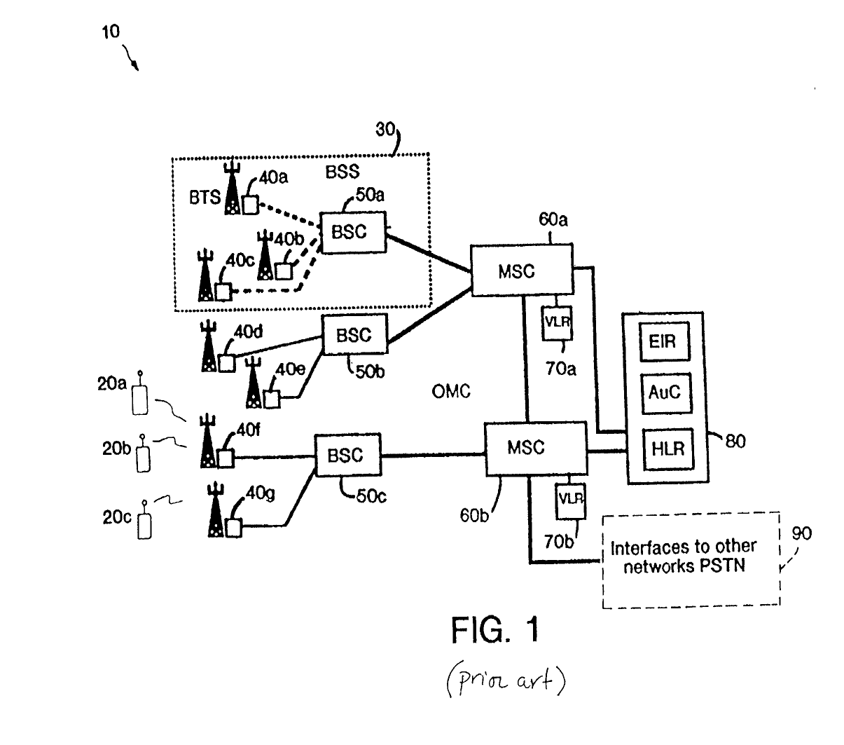

FIG. 1 depicts a cellular network or system 10 showing a number of mobile stations (MS) 20 (singularly 20a, 20b and 20c) communicating with base transceiver station (BTS) 40 (singularly 40a through 40g). When a MS 20 initiates a call to a BTS 40, it does so with an international mobile subscriber identification code (IMSI). BTS 40 sends the IMSI to one of a number of base station controllers (BSC) 50 (singularly 50a, 50b and 50c) and to one of a number of mobile services centers (MSC) 60 (singularly 60a and 60b) for authentication. The MSC 60 determines if the IMSI matches one in an associated visitor location registry (VLR) 70 (singularly 70a and 70b). If the IMSI is not found in VLR 70, MSC 60 looks into a home location registry (HLR) 80 to try to match the IMSI. If the IMSI is not found in HLR 80, MSC 60 looks out through the public switched telephone network (PSTN) 90 to try to match the IMSI in other network HLRs. Once authenticated, BTS 40 is authorized to communicate with MS 20 and the network places the call.

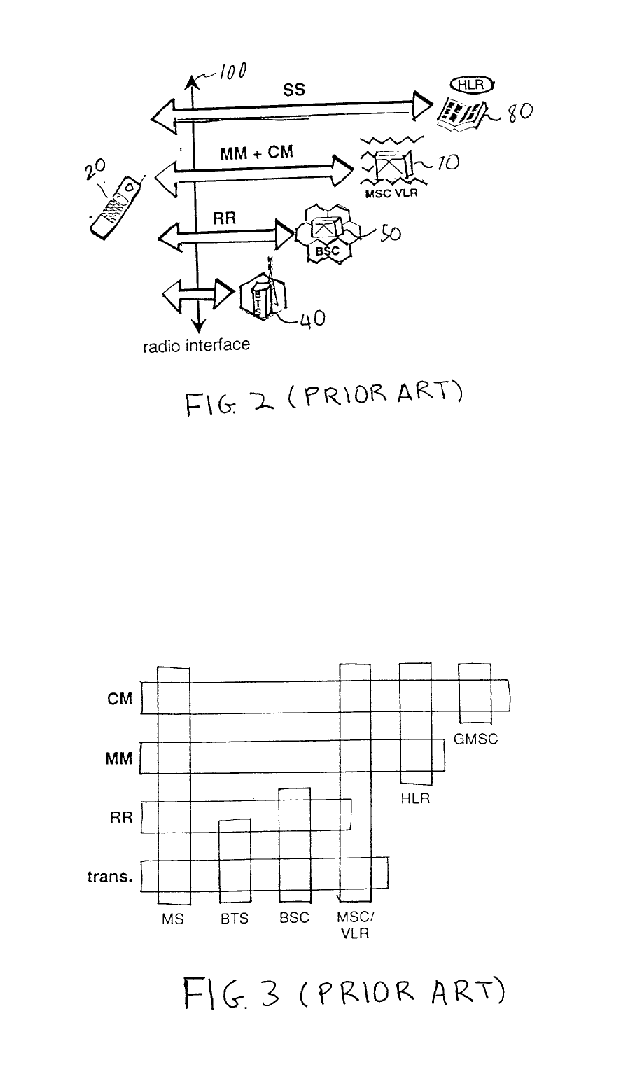

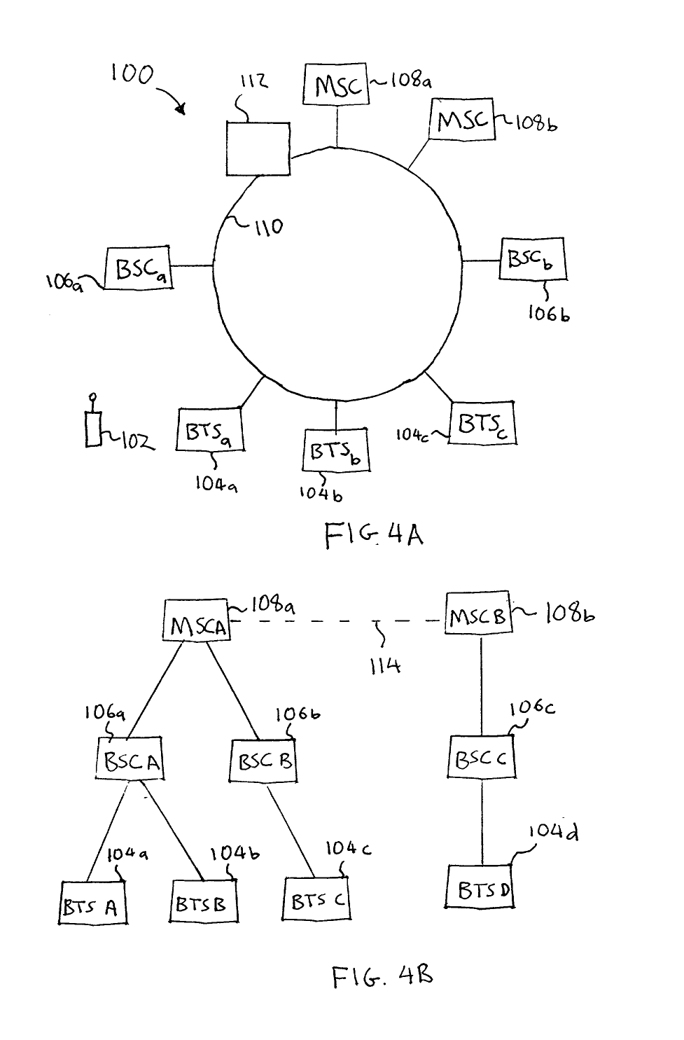

FIGS. 2 and 3 depict the association of GSM protocols with GSM interfaces. The GSM protocol involves several layers of communication between the MS and the GSM network. The radio interface is shown as vertical line 100. The layers include radio resources (RR), Mobility Management (MM) and Communication Management (CM), and Supplementary Services (SS). The RR is traditionally performed in the BSC, the MM and CM is traditionally performed in the MSC and the SS is traditionally performed in conjunction with the HLR. However, these functions do not need to be divided into specific hardware in the way shown in the prior art figures. That is the subject mater of the invention.

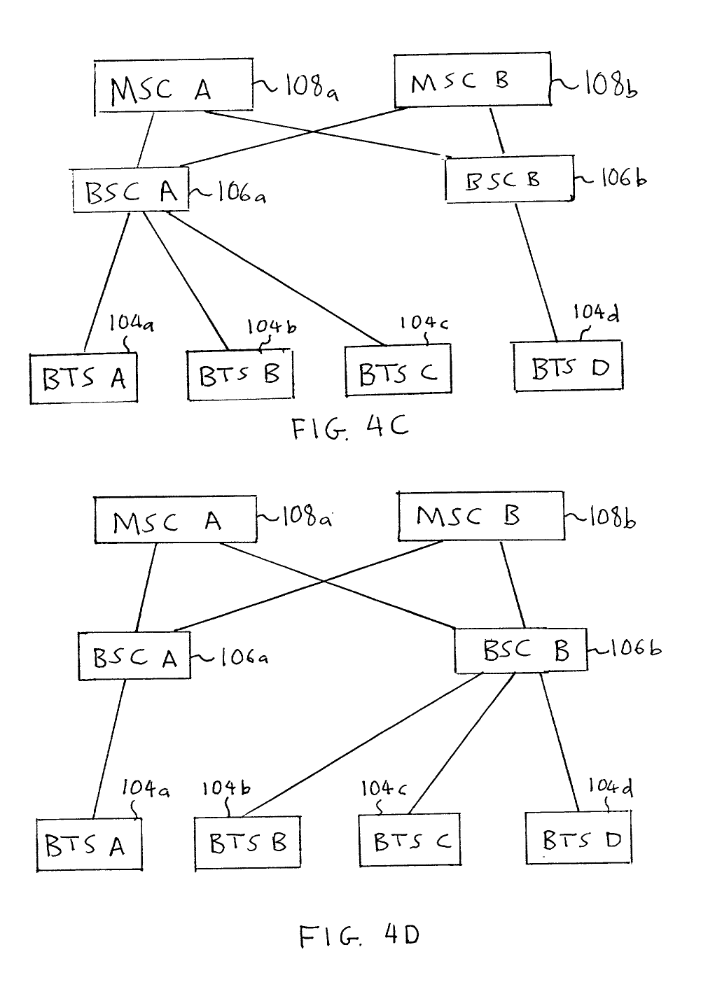

FIG. 4A depicts a cellular system 100 according to an embodiment of the invention for communicating with or between a plurality of mobile stations 102. The system 100 includes a number of network elements that constitute the system. The network elements include a number of base transceiver stations (BTS) 104a-104c, one or more base station controllers (BSC) 106a, 106b, and one or more mobile station controllers 108a, 108b. The network elements are coupled to one another over a circuit switched or packet switched network 110, for example, an Internet Protocol (IP) network, Asynchronous Transfer Mode (ATM) network or other type of network. While these elements are provided with conventional names BTS 104, BSC 106 and MSC 108, they do not necessarily have the same structures or functions as traditional BTS, BSC and MSC disclosed or depicted in the prior art. For example, the RR functions may be performed more efficiently in the BTS 104 than in the BSC 106 and therefore the BTS would perform the RR functions. Likewise, the MM or CM functions may be performed more efficiently in the BSC 106 than in the MSC 108 and therefore the BSC would perform those functions.

An optional network element in FIG. 4A is a gatekeeper 112. The gatekeeper 112 is designed to provide switching functions over an Internet protocol (IP) network in order to route calls and data. Examples of this functionality include those set forth by industry standards such as H323, H428 or Session Initiation Prorocol.

The network elements shown in FIG. 4A each include a network adapter (not shown) that is configured to couple to the network 110 and to employ a protocol used by the network. An example of such a network adapter is a trunk module, a sophisticated module that often includes a plurality of signal processors and an interface framer coupled to a time/space switch which is capable of routing information between a TDM bus and the signal processors and interface framers. The trunk module performs any necessary rate adaptation, echo cancelling, or interface functions. Trunk modules are described in more detail in, for example, U.S. Pat. No. 5,734,979, which is incorporated herein by reference. Additionally, the network elements each have an address so that data can be directed to the network elements. The network addresses make it possible to logically connect the network elements as described below.

B. Logical Communications

FIGS. 4B through 4E depict exemplary logical communications connections of a cellular system 100 such as shown in FIG. 4A. One advantage of the system 100 shown in FIG. 4A is that any of the BTS network elements 104 can communicate with any of the BSC network elements 106, and any of the BSC network elements can communication with any of the MSC network elements 108. This advantageously provides an architecture capable of balancing communication processing or messaging load, including control signal or messages and data.

FIG. 4B shows a logical connection of the network elements that forms a cellular system 100 ordered similar to a traditional cellular base station system. Referring to FIG. 4B, BTSs 104a, 104b, are coupled to BSC 106a, which in turn is coupled to MSC 108a. MSC 108a is also coupled to BSC 106b, and through the BSC to BTS 104c. MSC 108b, BSC 106c and BTS 104d can form a separate system or subsystem that is optionally linked to MSC 108a via a link 114, shown in phantom, or via the PSTN (not shown in this figure). According to the conventional architecture, there would be dedicated wires between the BTS, BSC and MSC. However, in the invention, the communication between the network elements is accomplished over the network 110 This advantageously allows a system controller function in MSC 108a, or for example in gatekeeper 112, to direct communication, signaling and messaging traffic to network elements that have available bandwidth.

FIGS. 4C and 4D illustrates how traffic can be routed from BSC A 106a to BSC B 106b in case of an overload at BSC A. For example, if the traffic from BTS A 104a is very heavy, while the traffic from BTS B 104b, BTS C 104c and BTS D 104d is relatively light, the architecture of the present invention would permit the system 100 to be transformed or re-configured to the logical connection shown in FIG. 4D in which BSC B 106b handles traffic with BTS B 104b, BTS C 104c and BTS D 104d, freeing resource of BSC A 106a to permit it to dedicate more, or in the example shown all, processing resources on the traffic from BTS A 104a. This would provide better call response to mobile stations 102 serviced by BTS A 104a, while still maintaining good call coverage in the other areas served by BTS B 104b, BTS C 104c and BTS D 104d.

FIG. 4E demonstrated how traffic can be routed in the event of a failure of a network element. For example, if BSC A 106a fails, the traffic from BTS A 104a and BTS B 104b is simply re-routed over to BSC B 106b as well as any call state information.

One interesting aspect of cellular communications systems is that the mobile station traffic can congregate at specific locations during particular times and cause undue loading on specific network elements. For example, there may be a large amount of traffic in a cell through which a freeway passes during commute hours and less traffic during non-commute hours. In the past conventional cellular communications systems or networks were designed to handle the maximum amount of anticipated communication traffic and hardware deployed accordingly. Since the conventional system was designed to handle the traffic during commute hours, there is excess capacity during non-commute hours. This is an inefficient deployment of hardware resources. The invention addresses this issue.

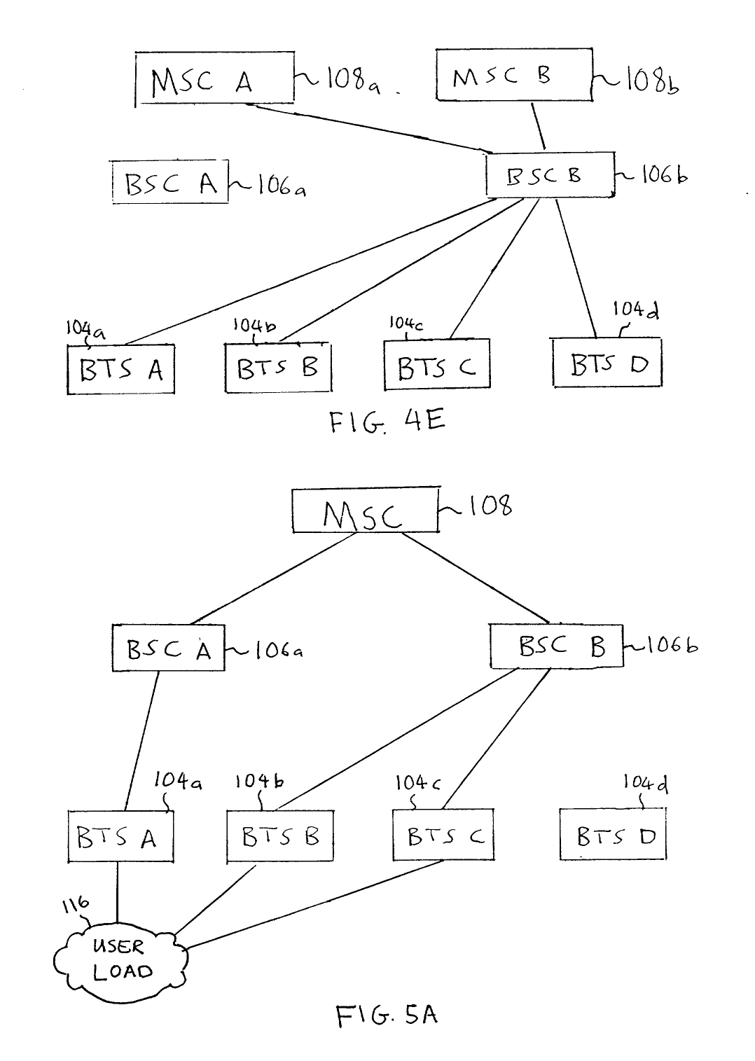

FIGS. 5A-C depict logical communications connections of the cellular network of FIG. 4A based on mobile station loads 116. FIG. 5A depicts, for example, a morning rush hour where the users are congregated on a freeway near BTS A 104a and the primary load is on BTS A, BTS B 104b and BTS C 104c. The invention provides that the communication traffic from any of the BTS network elements 104 can be transmitted to any of the available BSC network elements 106. Therefore, the communication traffic from BTS B 104b is divided between BSC A 106a and BSC B. The result is that BSC A 106a and BSC B 106b are processing approximately the same load.

FIG. 5B depicts, for example, a lunch event nearby where the users are out at a shopping mall or other group of restaurants near BTS D 104d and the primary load is on BTS B 104b, BTS C 104c and BTS D 104d. The invention provides that the communication traffic from any of the BTS network elements 104 can be transmitted to any of the available BSC network elements 106. Therefore, the communication traffic from BTS B 104b is divided between BSC A 106a and BSC B 106b. The result is that BSC A 106a and BSC B 106b are processing approximately the same load.

FIG. 5C depicts a fault event, for example, the failure of BTS C 104c. In this case, the communication traffic is directed to BTS B 104b and BTS D 104d, and they further send communication traffic equally to BSC A 106a and BSC B 106b. Again, the result is that BSC A 106a and BSC B 106b are processing approximately the same load.

C. Alternate Network Elements

In accordance with one aspect of the present invention, there is provided a a concentrated base transceiver station (CBTS) architecture in which the transceiver (TRX) is divided into two subsystems: a central transceiver (CTRX) subsystem which co-resides with the CBTS and a remote transceiver (RTRX) subsystem which is geographically remote from the CBTS and the CTRX. This aspect of the invention is described in U.S. patent Ser. No. 08/914,982, filed Aug. 20, 1997, incorporated herein by reference. In accordance with this aspect of the invention, the RTRX includes the RF antenna circuitry that is employed for transmitting outbound information and receiving inbound information with the mobile stations via RF signals. The outbound information and inbound information includes both signaling information and data information.

The antenna circuitry in each RTRX converts the outbound data from a digital format into RF signals for transmission to the mobile stations and converts RF signals from the mobile stations into digital inbound data for processing by the cellular network. Although additional processing capabilities may be built into the RTRX if desired, it is in general preferable to keep the circuitry within the RTRX minimized in order to simplify maintenance and upgrade. Additionally, since the RTRX may be implemented in hard to reach locations (e.g., locations which offer optimal transmission quality such as the top of building or other structure) or be exposed to weather elements, minimal RTRX designs promote ruggedness, which reduces maintenance costs.

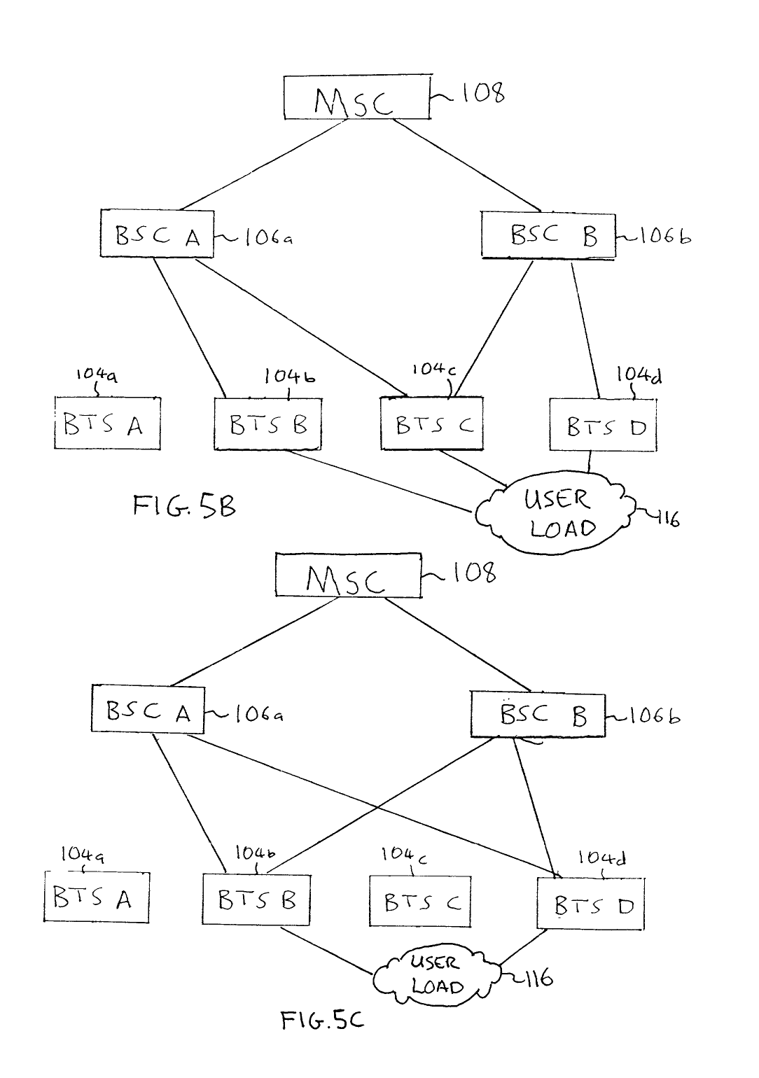

FIG. 6 illustrates, in accordance with one embodiment of the invention, a CBTS 118 including Abis interface 120. In CBTS 118, the antenna circuitry is implemented in RTRX subsystems 122a-110e. Although each RTRX 122 is shown with a single antenna 124, they may be implemented with separate transmit and one or more receive antennas. Each RTRX 122 preferably includes the antenna circuits, e.g., the radio interface circuitry, as well as circuitry to process, in the uplink direction, the received RF signals into binary data bits to be sent to the CTRX (discussed below). Additionally, each RTRX preferably includes circuitry to process the downlink binary data bits received from the cellular network (via the CTRX) into RF signals to be transmitted to the mobile stations.

A plurality of CTRXs 126a, 126b, are implemented in CBTS 118. Each CTRX 126 includes an RF quality control section. Each CTRX 126 is coupled at any given time to a unique set of RTRXs. In the implementation shown, RTRXs 122a, 122b, are coupled to CTRX 126a while RTRXs 122d-122e are coupled to CTRX 126b. The coupling between a RTRX 122 and its CTRX 126 may take place through any appropriate transmission medium including, for example, twisted pairs, co-axial cables, or fiber optics. In one embodiment, the transmission medium represents a twisted pair, and the traffic data, the radio control and status are passed between the CTRX 126 and the RTRX 122 through an Asynchronous Transfer Mode (ATM) link using a digital baseband physical layer protocol (T1, E1, E2, E3, DS1, DS3, or the like). Alternately or additionally, an Internet Protocol (IP) communication technique can be employed. Although each set of RTRXs 122 is shown in FIG. 6 to be in a daisy-chain arrangement, individual RTRXs may be coupled to their associated CTRX 126 in parallel.

In general, any number of RTRXs 122 may be coupled to a CTRX 126, and data from each RTRX may bear an appropriate identifier to permit the CTRX to identify the RTRX from which the data is sent. In practice, the number of RTRXs 122 may be limited to a reasonable number to suit the processing capabilities of the CTRX 126 or to avoid overwhelming the transmission channel between the RTRXs and the CTRX. If the physical layer framing on transmission channel 128a is E1 (30 DSOs), about 5 or 6 (or more if capacity permits) RTRXs works well. For E2 physical layer framing, about 22 (or more if capacity permits) RTRXs may be daisy-chained to a CTRX. For E3 physical layer framing, a greater number (e.g., 88 or even more) RTRXs may be daisy chained due to the greater bit rate on the transmission channel.

Since the RTRXs are remotely separated from the CBTS (e.g., via cabling), the CBTS needs not be considered the base of the cell. With the present invention, each CTRX now effectively defines an aggregate cell, which is made up of the radio cells of the associated RTRXs. The RTRXs themselves, being remotely separated from the CTRX may be dispersed anywhere within the cell and may even be interspersed among RTRXs that are associated with other CTRXs. It should be appreciated that the multiplicity of sets of RTRXs, as well as their ease of positioning, offers the service provider flexibility in cell shaping in a manner that is simply unattainable in the prior art.

The individual radio cell may of course be shaped further using traditional antenna techniques, e.g., using directional antennas or increasing the transmit power. If transmit power is increased, the additional heat and power generated do not pose a danger to the processing circuitry of the CBTS as in the case of the prior art BTS circuitry, which are co-resident with the antennas of the prior art TRXs. On the other hand, it is typically the case that a given area previously covered by a high power TRX may be covered as well by multiple RTRXs, each transmitting at a lower power level. In this manner, a given area may be covered with an array of simple, rugged and lower power RTRXs, thereby substantially reducing the costs of implementing the BTSs, as well as minimizing the potential for cell-to-cell interference, and/or improving frequency reuse. The ability to employ lower power antennas while offering equivalent or better coverage in a given area is a significant advantage of the invention.

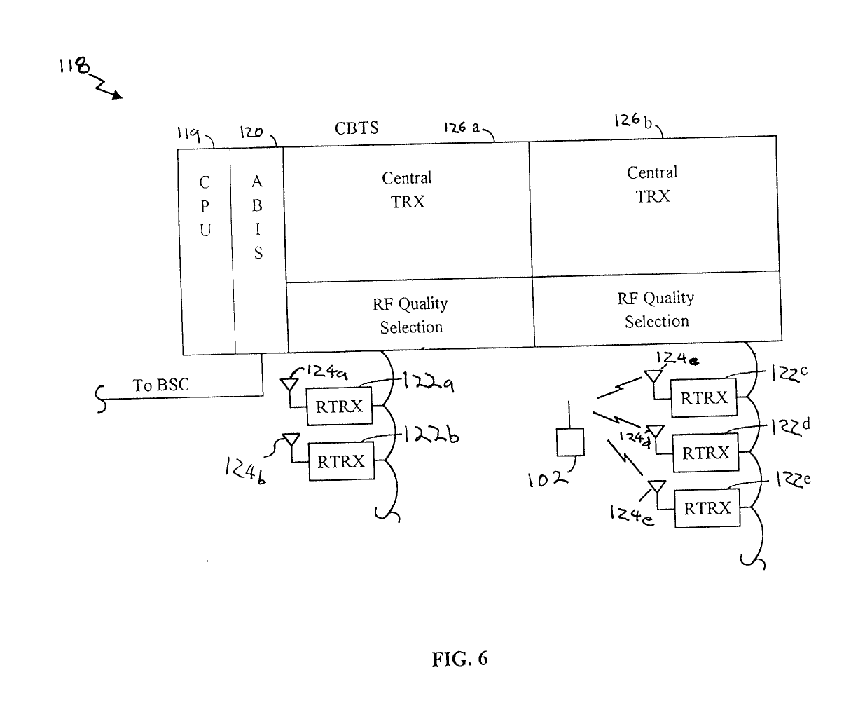

In FIG. 6, each set of RTRXs is shown directly coupled to its associated CTRX via the appropriate transmission medium. FIG. 7 depicts an alternate CTRX 126 RTRX 122 implementation where routing resources are provided in both the RTRXs and the CBTS 118 to facilitate dynamic assignment of, for example, CBTS Digital Signal Processing (DSP) resources to RTRXs 122 of the aggregate cells. In this implementation RTRXs 122a-122e are daisy-chained to a routing circuit 128; In one aspect, routing circuit 128 represents an Asynchronous Transfer Mode (ATM) routing circuit. Alternately or additionally, an Internet Protocol (IP) communication technique can be employed. A database, table, or intelligent algorithm controlling routing circuit 128 determines which RTRX is assigned to which of CTRXs 126a-126c. In this case, each RTRXs is associated with a unique ATM or IP address and provided with appropriate ATM or IP framing circuits to packetize the demodulated RF data for transmission to routing circuit 128 or to depacketize the ATM or IP data packets sent from the routing circuit. Traffic data, radio control, and status data may be packed into the ATM or IP cells for transmission between a RTRX and its associated CTRX at up to about two bursts per cell. Analogous techniques may be employed if a Frame Relay Protocol is used.

D. Alternate Architectures

1) Combinations

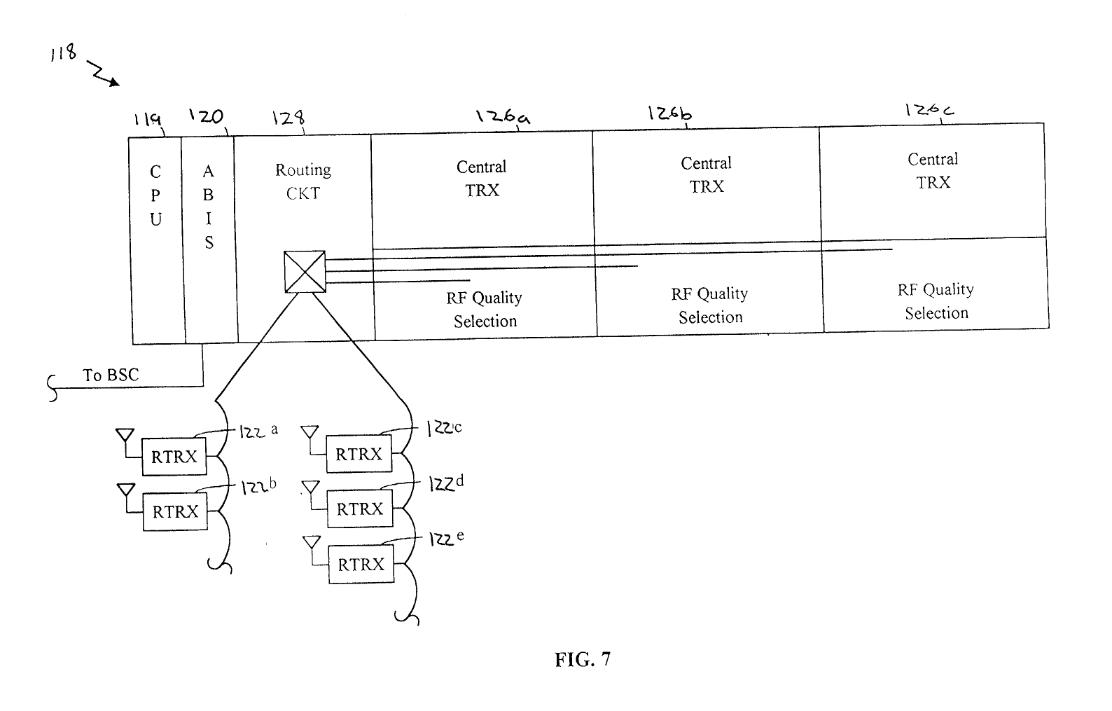

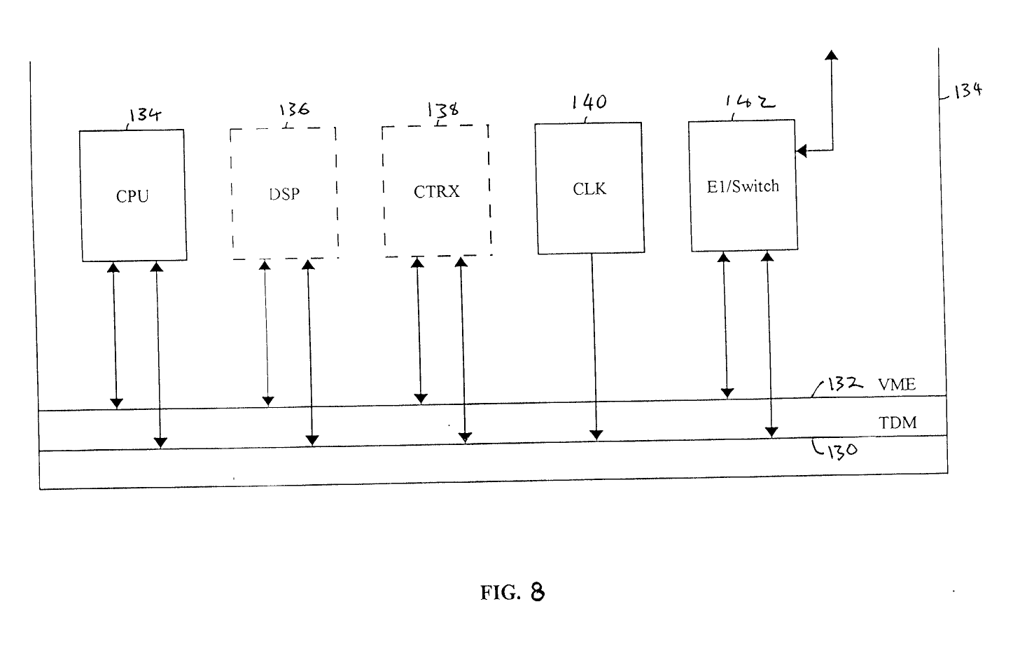

The architecture depicted in FIG. 1 can be compressed with or using a combination of components. For example, as described in U.S. Pat. No. 5,734,979. In this aspect if the invention, shown in FIG. 8, a modular and scalable architecture is implemented with a TDM bus 130 and a VME bus 132. A chassis 134 provides support for the VME bus 132 and TDM bus 130 along a backplane. Elements, such as central processing unit (CPU) 134, are positioned in the chassis to connect to the backplane via a connector, as known in the art. The elements can be constructed on single, double, or more printed circuit boards. The elements define the resulting network component. The CPU 134, digital signal processor (DSP) 136 and CTRX 138 are coupled to both the VME bus 132 and TDM bus 130. A clock module 140 is coupled to the TDM bus 130 and generates the reference clock which allows the subsystems to operate in a synchronized fashion. The trunk module 142 having an E1/switch is coupled to both the VME bus 132 and the TDM bus 130. FIG. 8 depicts a one-TRX BTS configuration, which is also depicted in FIG. 9.

FIG. 9 depicts a CBTS 118 with two CTRXs, an RF distribution card, a CPU and an E1 card. The chassis can operate as a stand alone unit, or can be mounted to an equipment rack for deployment in the field. Moreover, any card can be placed in any slot. It is possible, by removing all CTRXs, to build BSC or MSC configurations using just trunk module and CPU cards.

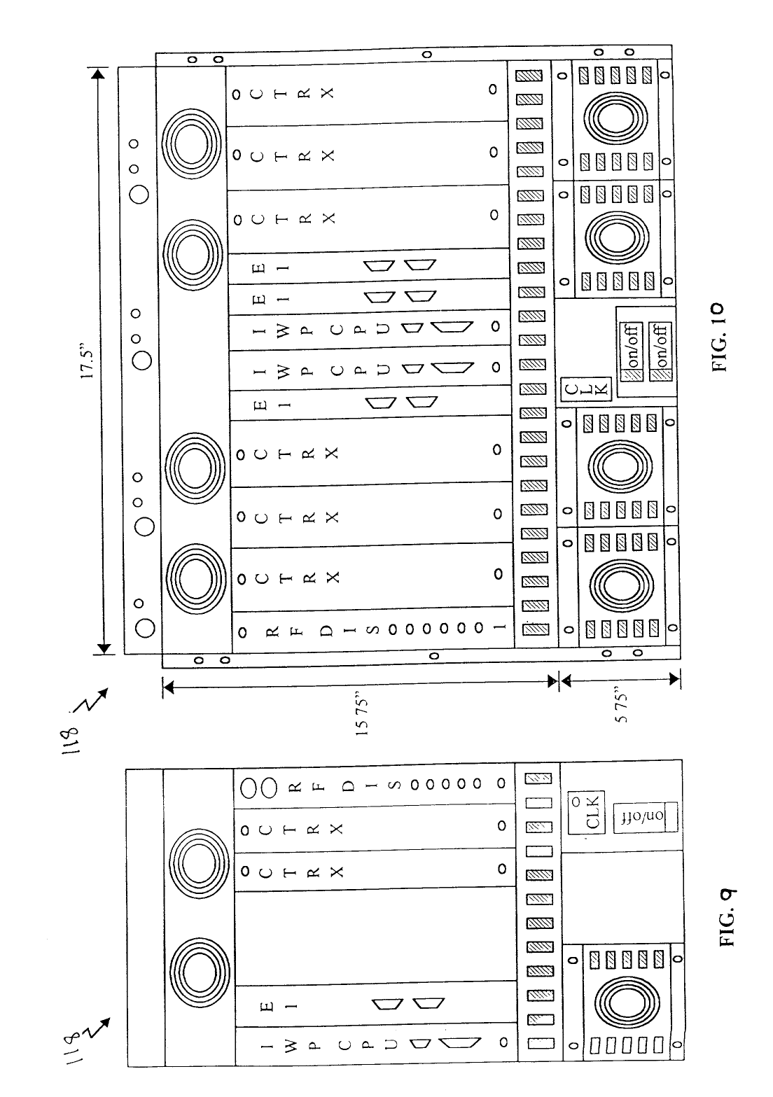

Since the architecture is fully scalable, FIG. 10 depicts a base station having six TRXs, two CPUs, and three trunk modules. Any base station configuration and function can be accommodated by selecting processing elements for deployment. Various possible functions, such as BTS, BSC, combined BTS/BSC, MSC, combined BSC/MSC, and combined BTS/BSC/MSC can be achieved with the invention. A configuration having a single CTRX and single trunk module is possible when the CPU functions are incorporated in the CTRX processor and trunk module processor.

In order to achieve the collapsing functions, the trunk module 142 is employed to accommodate different information rates. Referring back to FIGS. 6 and 7, the framers are coupled to time/space switch 402 via 2 Mbps framer ports TxA and TxB. The 2 Mbps is an E1 interface rate, but can be modified for any interface rate. The framers are configured to communicate with other network elements such as a BTS, BSC, MSC, PBX, PSTN, or others. Since the base station can be configured to perform the functions of a BTS, BSC, or MSC, the type of interface may be changed to accommodate the particular required interface function. For example, the framers shown in FIG. 7 can interface with an E1 bus or trunk at 2 Mbps, a T1 at 1.544 Mbps, DSO at 64 Kbps, or other digital interface.

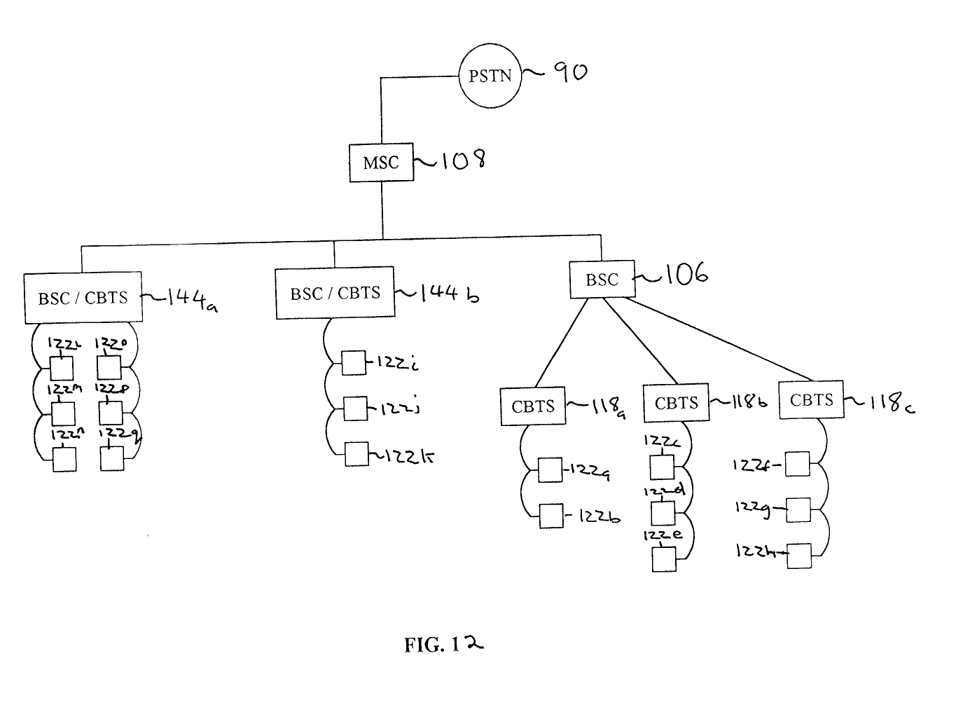

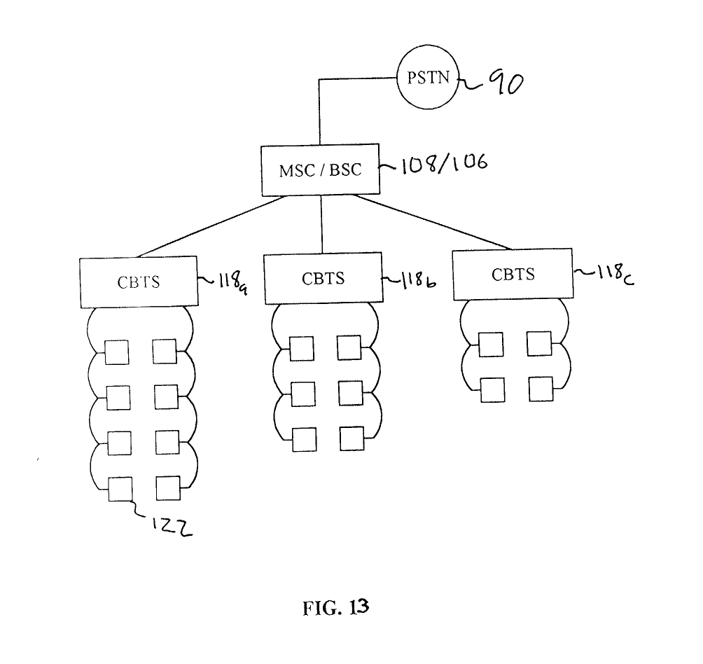

FIGS. 12 and 13 depict network components that are constructed from elements connected in the chassis 134.

FIG. 12 depicts a network architecture where the BSC and CBTS functions are combined in the same chassis. A chassis configured to perform this network component could have a plurality of CTRXs, a trunk module, a CPU, clock card and an RF distribution card. Routing functions described above for routing calls through the BSC or CBTS are now routed through the BSC/CBTS combination. To accomplish some of these switching techniques the Abis interface is implemented as a faux Abis. This implementation is discussed in greater detail in U.S. Pat. No. 5,734,979.

FIG. 13 depicts a network architecture where the MSC and BSC functions are combined in the same chassis. A chassis configured to perform this network component could have a trunk module, a CPU and a clock card. Routing functions described above for routing calls through the MSC or BSC are now routed through the MSC/BSC combination. To accomplish some of these switching techniques the A interface is implemented as a faux A. This implementation is discussed in greater detail in U.S. Pat. No. 5,734,979.

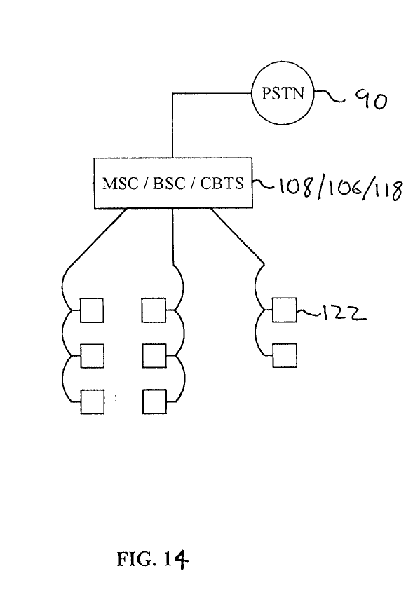

FIG. 14 depicts a network architecture where the MSC, BSC and CBTS functions are combined in the same chassis. A chassis configured to perform this network component could have a plurality of CTRXs, a trunk module, a CPU, a clock card and an RF distribution card. Routing functions described above for routing calls through the CBTS, BSC or MSC are now routed through the MSC/BSC/CBTS combination. To accomplish some of these switching techniques the A interface is implemented as a faux A and the Abis interface is implemented as a faux Abis. This implementation is discussed in greater detail in U.S. Pat. No. 5,734,979.

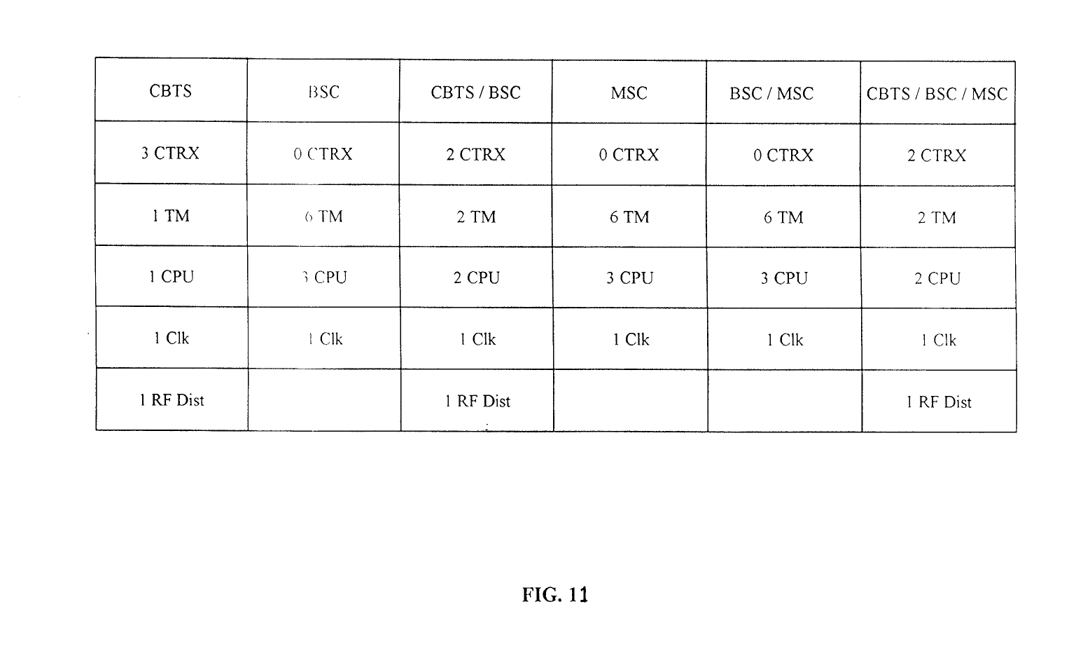

A significant advantage of the scalable architecture is that when trunk module cards are added, the switching ability of the base station increases. For example, by configuring a base station with three trunk modules, as shown in FIG. 11, the base station capacity is increased to six E1 output ports. This configuration provides both greater communication capacity to a MSC, as well as greater information switch capacity within the base station itself, such as between CTRX cards.

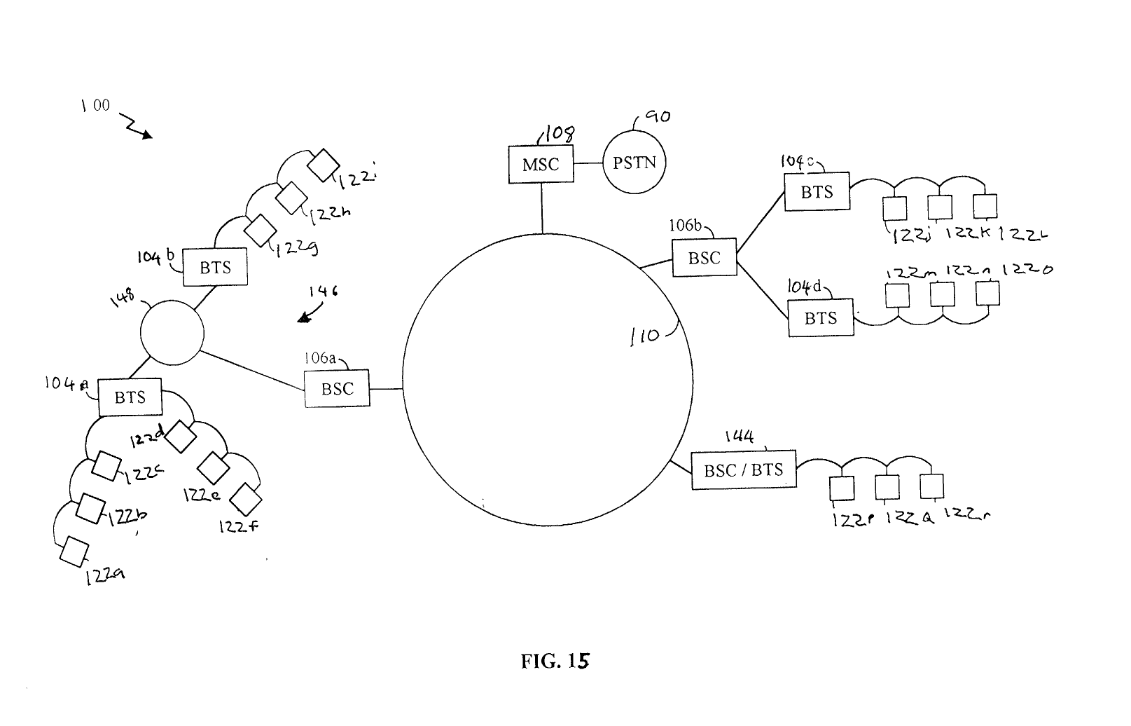

2) Alternate Communication Architectures FIG. 15 depicts a system 100 having a ring architecture where the BSC components 106a-106b and a combined BSC/CBTS component 144 comprise a structure to switch information between respective CBTSs 104a-104b and MSC 108 over a bus or network 110. The bus 110 can be an E1 bus, for example, that transports information to and from the network components using an ATM protocol, IP protocol or Frame Relay protocol. A sub-network 146 is configured with CBTS 104a and 104b by coupling these components to a separate bus or network 148 and BSC A 106a. This configuration is beneficial because each of the network components has access to other network components that is uses to communicate information between mobile stations in the network and the PSTN 90.

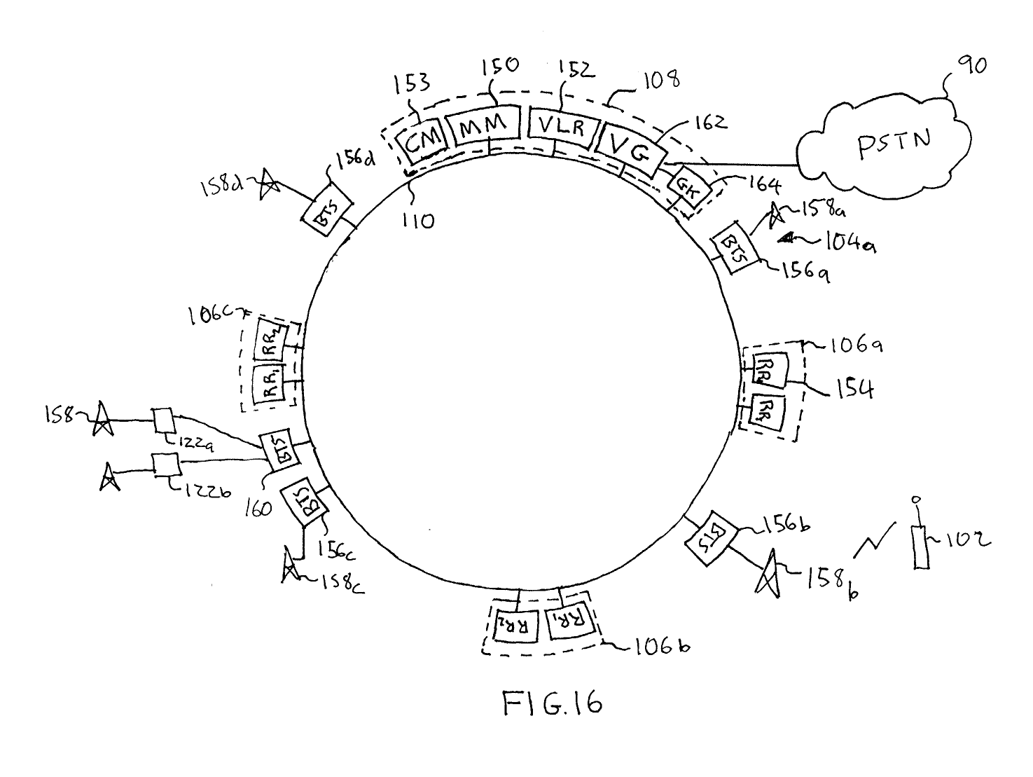

FIG. 16 depicts an architecture in which the communication system 100 comprises a number of independent computer programs or software functional blocks, each capable of performing functions of one of the components of the communication system described above, for example, the MSC 108, BSC 106 and BTSs 104 The software functional blocks, are resident on one or more data processing systems or servers (not shown) coupled to one another by a network 110 over which communication signals or data and controls signals are communicated or transmitted. The network 110 can be either a circuit switched network or a packet switched network, such as an internet protocol (IP) networks and asynchronous Transfer Mode (ATM) networks. Preferably, the network 240 is an IP network, such as a local area network (LAN), wide area network (WAN) or the Internet.

Generally, the software functional blocks include mobility management (MM) functional blocks 150 for implementing MM functions, visitor location registry (VLR) functional blocks 152 for implementing VLR functions, a communication management (CM) functional block 153 to implement CM functions, and a number of radio resources (RR) functional blocks 154 for implementing RR functions. The BTS 104 can include a number of discreet individual or standalone hardware and software units 156A, 156 B, 156C, 156D, each with a tower 158 or antenna associated therewith, and each coupled to the network 110. Alternatively, the BTS 104 can include a BTS software functional block 160 resident on a data processing system or server coupled to the network 110, and one or more remote transceivers or RTRXs 122A, 122B, each with a tower 158 or antenna associated therewith, coupled to the BTS software functional block.

In one embodiment, network 110 is a packet switched network and the communication system 100 further includes a voice gateway and a gatekeeper coupled to the network and to the PSTN 90 to facilitate communication between the PSTN and the mobile stations 102. Generally, the voice gateway includes a voice gateway software functional block 162 for converting or translating voice, data, and control signals or communications passed over the PSTN 104 to packets passed over the packet switched network 110, and the gatekeeper 164 routes or directs the packets over the network.

In another embodiment, the various software functional blocks can be combined or stored on one or two closely coupled data processing systems to form or create MSCs 108 and BSCs 106. For example, in the embodiment shown the MM functional block 150, the VLR functional block 152 and the voice gateway software functional block 162 can be resident on a single special purpose data processing system to serve as a MSC 108. Similarly, one or more RR functional blocks 154 on another special purpose data processing system can serve as a BSC 106.

Some of the important aspects of the present invention will now be repeated to further emphasize their structure, function and advantages.

According to one aspect of the present invention, a distributed cellular communication system is provided. Generally, the communication system includes a network, a public switched telephone network (PSTN) coupled to the network, a number of base transceiver stations (BTSs) coupled to the network, and at least one data processing system or server coupled to the network, the data processing system configured to execute computer programs including software functional blocks adapted to enable the BTSs to communicate data between mobile stations and between a mobile station and the PSTN. The data communicated between mobile stations and between a mobile station and the PSTN typically includes voice communication. Preferably, the BTSs are geographically separated from one another and are each configured to communicate over a wireless medium with mobile stations in an associated cell. More preferably, the software functional blocks include a mobility management (MM) functional block to implement MM functions, a visitor location registry (VLR) functional block to implement VLR functions, and a number of radio resources (RR) functional blocks to implement RR functions. The CM functions implemented by the CM functional block 153 include establishing communication between a mobile station and the network by switching communication among the BTSs as the mobile station moves from one cell to another. The RR functions implemented by the RR functional blocks include maintaining communication between a mobile station and the network by switching communication among the BTSs as the mobile station moves from one cell to another. The distributed and modular nature of the inventive communication system enable the communication traffic to be load-balanced among the available BTSs and the software functional blocks to provide increased efficiency unparalleled in conventional communication systems.

The network can be either a circuit switched network or a packet switched network, such as internetprotocol (IP) networks and asynchronous TransferMode (ATM) networks. In one preferred embodiment, the network is an IP network, and the PSTN is coupled to the IP network via a voice gateway. More preferably, the voice gateway includes a voice gateway functional block with software for implementing functions including: (i) converting between voice communication or signals transmitted over the PSTN and packets transmitted over the IP network, and (ii) routing the packets over the IP network. In one version of this embodiment, the voice gateway software functional block, the MM functional block and the VLR functional block are resident on a special purpose data processing system to form a mobile services center (MSC). Alternatively or additionally, one or more of the RR functional blocks can be resident a second special purpose data processing system to form a base station controller (BSC).

In an alternative embodiment, the BTSs consist of a transceiver and a BTS software functional block resident on a data processing system coupled to the network. Optionally, each BTS software functional block is associated with a number of separate transceivers serving separate cells or micro-cells with a single larger cell served by the BTS software functional block.

In another aspect the present invention is directed to a distributed cellular network including: a number of base transceiver station network elements and/or software functional blocks configured to communicate with a number of mobile stations over a wireless medium, each base transceiver station having a network interface adapted to couple to a network; a number of base station controller network elements each including a network interface adapted to couple to the network; and at least one mobile station controller network element including a network interface adapted to couple to the network. Each of the network elements is given a predetermined network address and communication traffic is routed to each of the network elements based on the predetermined network addresses.

In one embodiment, the communication traffic for each of the network elements is routed so as to balance the processing load among the network elements. Optionally, if one of the network element fails, communication traffic is routed to another network element capable of performing the required functions.

In an alternative embodiment, one of the network elements is a gatekeeper and is configured to manage voice communications over an internet protocol (IP) network. Preferably, voice communications internal to the network are routed by the gatekeeper before sending the voice communications to an external network.

In yet another aspect of the present invention, a method is provided for communicating with a number of mobile stations using a distributed cellular network having a number of network elements. Generally, the method involves steps of: (i) communicating inbound information with a mobile station over a transceiver network element; (ii) communicating the inbound information with one of at least two base station controller network elements to further process the inbound information; (iii) communicating the inbound information with a mobile station controller network element to further process the inbound information; and (iV) the communicating steps include communicating network traffic among the network elements is load-balanced for efficiency.

In one embodiment, each of the network elements is given a predetermined network address and the step of communicating the network traffic includes routing to each of the network elements based on the predetermined network addresses. Preferably, the communicating steps include routing network traffic for each of the network elements so as to balance the processing load among the network elements. More preferably, if one of the network element fails, communication traffic is routed to another network element capable of performing the required functions.

In another embodiment, one of the network elements is a gatekeeper, and the communicating steps include managing voice communications using an internet protocol network. Preferably, voice communications internal to the network are routed by the gatekeeper before sending the voice communications to an external network.

E. Conclusion

The invention provides many advantages over known techniques. One advantage of the invention is a combination of low-cost transceiver and flexible deployment to gain communication coverage over a large area at a low cost. This permits cellular system engineers to design cellular coverage for virtually any physical space. Additional advantages to aspects of the invention include modularity, scalability, distributed processing, improved performance, reduced network congestion, fault tolerance, and more efficient and cost-effective base stations.

In particular, since multiple RTRXs may be coupled to a single CTRX and each CBTS may have a plurality of CTRXs, the inventive architecture offers great flexibility in configuring the cell. Cell shaping is no longer limited to modifying antenna shape and transmit range around the BTS. With the inventive CBTS architecture, cabling can be run from a CTRX to any number of geographically dispersed RTRXs to form an aggregate cell out of the geographically dispersed radio cells. Further, with multiple CTRXs in each CBTS, the service provider has beneficial tools for configuring the cellular network.

These inexpensive low-power RTRXs may now be employed in place of the high power TRX of the prior art to cover the same area. Beside reducing the costs of the radio circuits, the invention also promotes frequency reuse since each radio cell (associated with each RTRX) may be smaller. Also as discussed, the ability to dynamically associate one or more RTRX with a given CTRX offers the service provider great flexibility in reconfiguring the cell to adapt to changes in capacity using the existing set of RTRX/CTRXs or additional RTRX/CTRXs.

The foregoing description of specific embodiments and examples of the invention have been presented for the purpose of illustration and description, and although the invention has been illustrated by certain of the preceding examples, it is not to be construed as being limited thereby. They are not intended to be exhaustive or to limit the invention to the precise forms disclosed, and obviously many modifications, embodiments, and variations are possible in light of the above teaching. It is intended that the scope of the invention encompass the generic area as herein disclosed, and by the claims appended hereto and their equivalents.

What is claimed is:

1. A distributed cellular communication system comprising:
a network;
a public switched telephone network (PSTN) coupled to the network;
a plurality of transceiver coupled to the network, the plurality of transceivers geographically separated from one another and each configured to communicate over a wireless medium with mobile stations in an associated cell;
at least one data processing system coupled to the network, the at least one data processing system configured to execute computer programs including software functional blocks adapted to enable the plurality of transceivers to communicate data between mobile stations and between a mobile station and the PSTN, the software functional blocks including:
a mobility management (MM) functional block to implement MM functions;
a visitor location registry (VLR) functional block to implement VLR functions;
a communication management(CM) functional block to implement CM functions; and
a plurality of radio resources (RR) functional blocks to implement RR functions including maintaining communication between a mobile station and the network by switching communication among the plurality of transceivers as the mobile station moves from one cell to another cell.

2. A communication system according to claim 1, wherein communication traffic among the transceivers and the software functional blocks is load-balanced to provide increased efficiency.

3. A communication system according to claim 1, wherein the network is a network selected from a group comprising:
circuit switched networks;
internet protocol (IP) networks; and
asynchronous Transfer Mode (ATM) networks.

4. A communication system according to claim 1, wherein the network is an internet protocol (IP) network, and wherein the PSTN is coupled to the IP network via a voice gateway.

5. A communication system according to claim 4, wherein the voice gateway comprises a voice gateway functional block including software to implement functions including converting between voice communication transmitted over the PSTN and packets transmitted over the IP network, and routing the packets over the IP network.

6. A communication system according to claim 5, wherein the voice gateway software functional block, the MM functional block and the VLR functional block are resident on a special purpose data processing system known as a mobile services center (MSC).

7. A communication system according to claim 6, wherein at least one of the plurality of RR functional blocks is resident on a special purpose data processing system known as a base station controller (BSC).

8. A communication system according to claim 1, wherein the data communicated between mobile stations and between a mobile station and the PSTN includes voice communication.

9. A communication system according to claim 1, wherein the each of the plurality of transceivers includes a transceiver and a base transceiver station (BTS) software functional block resident on a data processing system coupled to the network.

10. A distributed cellular network for providing wireless communication with a plurality of mobile stations, comprising:
a plurality of base transceiver station network elements configured to communicate with the plurality of mobile stations over a wireless medium, wherein each base transceiver station includes a network interface adapted to couple to a network;
a plurality of base station controller network elements each including a network interface adapted to couple to the network;
at least one mobile station controller network element including a network interface adapted to couple to the network;
wherein communication traffic among the base transceiver stations, the base station controllers and the mobile switching center is load-balanced for efficiency.

11. The distributed cellular network of claim 10, wherein:
each of the network elements is given a predetermined network address and communication traffic is routed to each of the network elements based on the predetermined network addresses.

12. The distributed cellular network of claim 11, wherein:
the communication traffic for each of the network elements is routed so as to balance the processing load among the network elements.

13. The distributed cellular network of claim 11, wherein:
if one of the network element fails, communication traffic is routed to another network element capable of performing the required functions.

14. The distributed cellular network of claim 10, wherein:
one of the network elements is a gatekeeper and is configured to manage voice communications over an Internet protocol.

15. The distributed cellular network of claim 14, wherein:
the voice communications are preferably routed by the gatekeeper internal to the network before sending the voice communications to an external network.

16. A method of providing wireless communication with a plurality of mobile stations using a cellular network including a plurality of network elements, comprising the steps of:
communicating inbound information with a mobile station over a transceiver network element;
communicating the inbound information with one of at least two base station controller network elements to further process the inbound information;
communicating the inbound information with a mobile station controller network element to further process the inbound information;
the communicating steps include communicating network traffic among the network elements is load-balanced for efficiency.

17. The method of claim 16, wherein:
each of the network elements is given a predetermined network address and the step of communicating the network traffic includes routing to each of the network elements based on the predetermined network addresses.

18. The method of claim 17, wherein:
the communicating steps include routing network traffic for each of the network elements so as to balance the processing load among the network elements.

19. The method of claim 17, wherein:
if one of the network element fails, communication traffic is routed to another network element capable of performing the required functions.

20. The method of claim 16, where one of the network elements is a gatekeeper and wherein:
the communicating steps include managing voice communications using an Internet protocol.

21. The method of claim 20, wherein:
the voice communications are preferably routed by the gatekeeper internal to the network before sending the voice communications to an external network.
